(19) United States
(12) Patent Application Publication
(10) Pub. No.: US 2019/0174712 A1
(43) Pub. Date: Jun. 13, 2019

(54) APPARATUS, KITS AND METHODS TO FACILITATE CAT-HUMAN INTERACTION

(71) Applicant: Debra S. George, Saint Paul, MN (US)

(72) Inventor: Debra S. George, Saint Paul, MN (US)

(21) Appl. No.: 16/216,114

(22) Filed: Dec. 11, 2018

Related U.S. Application Data
(60) Provisional application No. 62/737,277, filed on Sep. 27, 2018.
(60) Provisional application No. 62/708,424, filed on Dec. 11, 2017.

(51) Int. Cl. A01K 1/03; A01K 15/02

(52) U.S. Cl. CPC A01K 1/033; A01K 15/025

(57) ABSTRACT

Apparatus, kits and methods for aiding interaction between a cat and a human can include packaging, and a playhouse configured for interaction between cats and human companions. The playhouse can include a collapsible enclosure having a wall and a floor, the wall defining an open perimeter opposite the floor. The collapsible enclosure can further define a floor aperture defined in through the wall and adjacent the floor, wherein the floor aperture has a size of about 100 mm by about 30 mm. The wall further defining a paw aperture having a size of about 40 mm by about 40 mm, and the wall can further define an eye aperture having a size of about 40 mm by about 40 mm. The kit can further include an instruction manual and a toy.

### RELATED APPLICATIONS

The present application claims the benefit of U.S. Provisional Application No. 62/708,424 filed on Dec. 11, 2017, and U.S. Provisional Application No. 62/737,277 filed on Sep. 27, 2018, each of which is hereby incorporated herein by reference in its entirety.

### TECHNICAL FIELD

Embodiments disclosed herein relate generally to containers and, more particularly, to kits and methods that facilitate safe interaction between a cat and its human companions.

### BACKGROUND

Cats are often stereotyped as reclusive, or when they are playing, as biters and scratchers. It is not necessarily the personality of the cat, however, that gives it that reputation, but rather the lack of an appropriate introduction to its new living environment and human companions. Oftentimes, reclusiveness results from not having anything stimulating to catch the cat's attention, and the scratching or biting results from the cat being scared or uncomfortable in its surroundings. Alternatively, the cat might be overstimulated by the well-intentioned, uneducated owner who extends a hand, and the cat naturally responds with its paws, claws or teeth. People who are first-time cat owners frequently do not understand the mental processes of cats and therefore are unaware of how to acclimate a cat to its new life in an environment that is designed for humans.

Some products are commercially available that help cats to feel welcome in their new spaces. For example, “cat trees” provide high places which cats enjoy, and a variety of cat toys, foods, and stimulants such as catnip can keep cats engaged in their new environment and prevent cats from hiding or becoming aggressive. Currently, each new cat owner is required to learn the particular nature of his or her cat and independently acquire each of the components that will provide a positive environment for the cat, often through trial and error. Cats are notorious for their unpredictable tastes, often preferring awkward spaces under beds or behind curtains to pet beds, or preferring the packaging to the new toys their people provide. While this is often endearing to a person who has cohabitated with a cat for a long time, it can be frustrating or confusing to a new cat owner.

As such, it would be advantageous if a solution were provided that would help cats successfully acclimate to new environments, and help the cats' human companions to encourage play and exercise of the cat while preventing unnecessary anxiety for the cat and physical harm for the humans.

### SUMMARY

According to an embodiment, a cat playhouse includes a collapsible enclosure having a wall and a floor, the wall defining an open perimeter opposite the floor. The collapsible enclosure further defines a floor aperture defined in through the wall and adjacent the floor, wherein the floor aperture has a size of about 100 mm by about 30 mm. The wall further defines a paw aperture having a size of about 40 mm by about 40 mm. The wall further defines an eye aperture having a size of about 40 mm by about 40 mm.

According to another embodiment, a kit for aiding interaction between a cat and a human includes packaging, a playhouse as described above, an instruction manual, and one or more toys or other enrichment objects for a cat.

According to another embodiment, a method for incorporating the kit into the process of adoption of cats includes providing new owners with the kit, subsequently recognizing that the cat needs a new kit, preparing the new kit, and delivering new kit to adopter.

### BRIEF DESCRIPTION OF THE DRAWINGS

The invention may be more completely understood in consideration of the following detailed description of various embodiments of the invention in connection with the accompanying drawings, in which:

FIG. 1 depicts a kit for safely playing with a cat according to an embodiment.

FIG. 2 is a perspective view of an erect playhouse with an exploded view of the bottom flaps, according to an embodiment.

FIG. 3A is a front perspective view of an example of an alternative embodiment of a playhouse.

FIG. 3B is a front perspective view of an alternative embodiment of a playhouse.

FIG. 4A is perspective view of a collapsed playhouse according to an embodiment.

FIG. 4B is front and back view of the collapsed playhouse of FIG. 4A.

FIG. 5 is a front view of an instruction manual according to an embodiment.

FIG. 6 depicts a method for incorporating the kit of FIG. 1 into the adoption of cats.

FIG. 7 is an exploded view of a kit according to an embodiment.

While embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

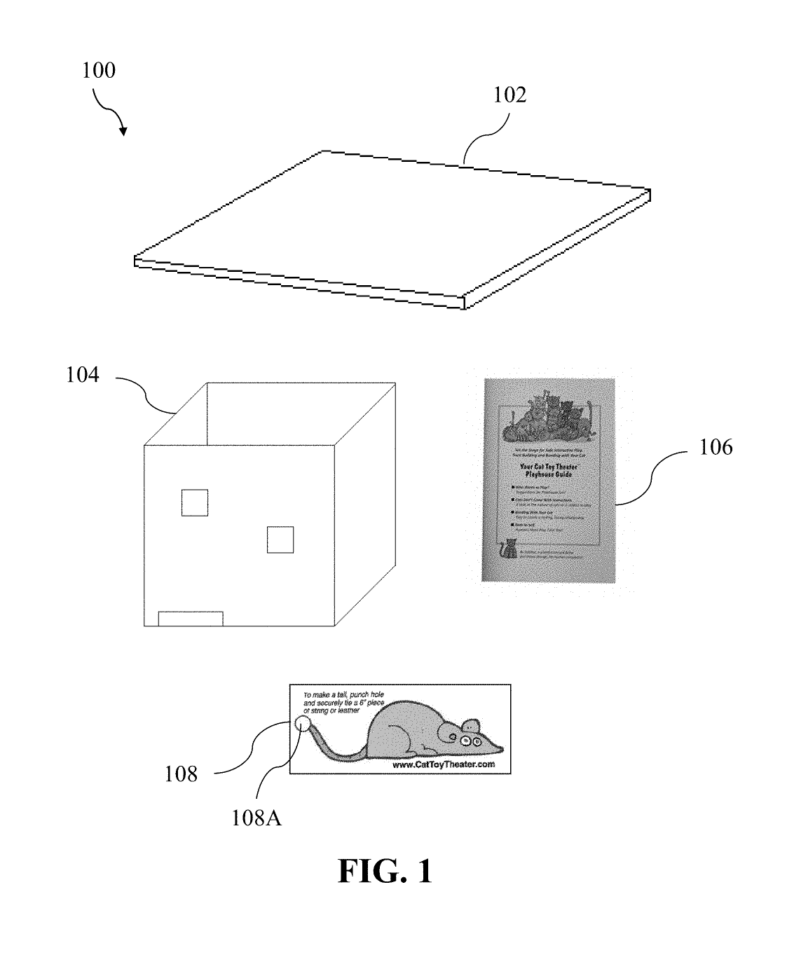

FIG. 1 illustrates an embodiment of a kit 100 comprising a packaging 102, a playhouse 104, an instruction manual 106, and a toy 108. Kit 100 is meant to aid in the interaction between humans and cats to help the cat acclimate to its new surroundings by encouraging playing and exercising, while also keeping the humans at a safe distance to remain free from bites or scratches. Kit 100 is also for the benefit of the new cat who will naturally seek safe haven while it acclimates to the new environment. On an ongoing basis, it can be a protected space to hide or rest. According to one embodiment, packaging 102 is a flat box typically made of cardboard, or some material with similar characteristics, which protects the rest of the kit during transport when playhouse 104 is in a collapsed configuration. The flat orientation of packaging 102 makes it more convenient to transport and store kit 100. In other embodiments, packaging 102 can take different shapes to accommodate a different playhouse 104, instruction manual 106, and/or toy 108.

Packaging 102 is a cardboard flatpack in FIG. 1, but in alternative embodiments could be made in different materials or sizes. Packaging 102 can be a convenient size and shape for shipping or so that it can be provided with cats at adoption from a shelter or pet store. In still other embodiments, part or all of packaging 102 can be combinable or integrated with playhouse 104.

For example, in one embodiment playhouse 104 itself is the packaging 102 or shipping container. In such an embodiment, playhouse 104 can contain other components of kit 100 for shipping. Portions of one or more surfaces of playhouse 104 can be designated for shipping labels in a way that does not interfere with exterior graphics or other features of playhouse 104 that will be visible when it is assembled and in use. Upon receipt, a user can open and assemble playhouse 104, which can include, but is not limited to, removing perforated flaps (to create an open wall on playhouse 104) or pre-punched or perforated sections (to form one or more apertures in the wall(s) of playhouse 104, described in more detail below). A user may also take other steps in some embodiments to customize playhouse 104 upon receipt, as instructed or desired, beyond the particular examples given here. Instead or in addition to removing portions of playhouse 104, in some embodiments a user may reconfigure portions of playhouse, add or attach additional portions or features (such as attaching a string or other toy to the playhouse), or otherwise transform playhouse 104 from a flatpack or other shipping state to a play state. Though playhouse 104 in a shipping state may in some instances be shrink-wrapped in plastic or some other protective material, this is not required. These embodiments therefore can reduce usage of disposable shipping materials, which may reduce costs or be attractive to users who want to reduce waste.

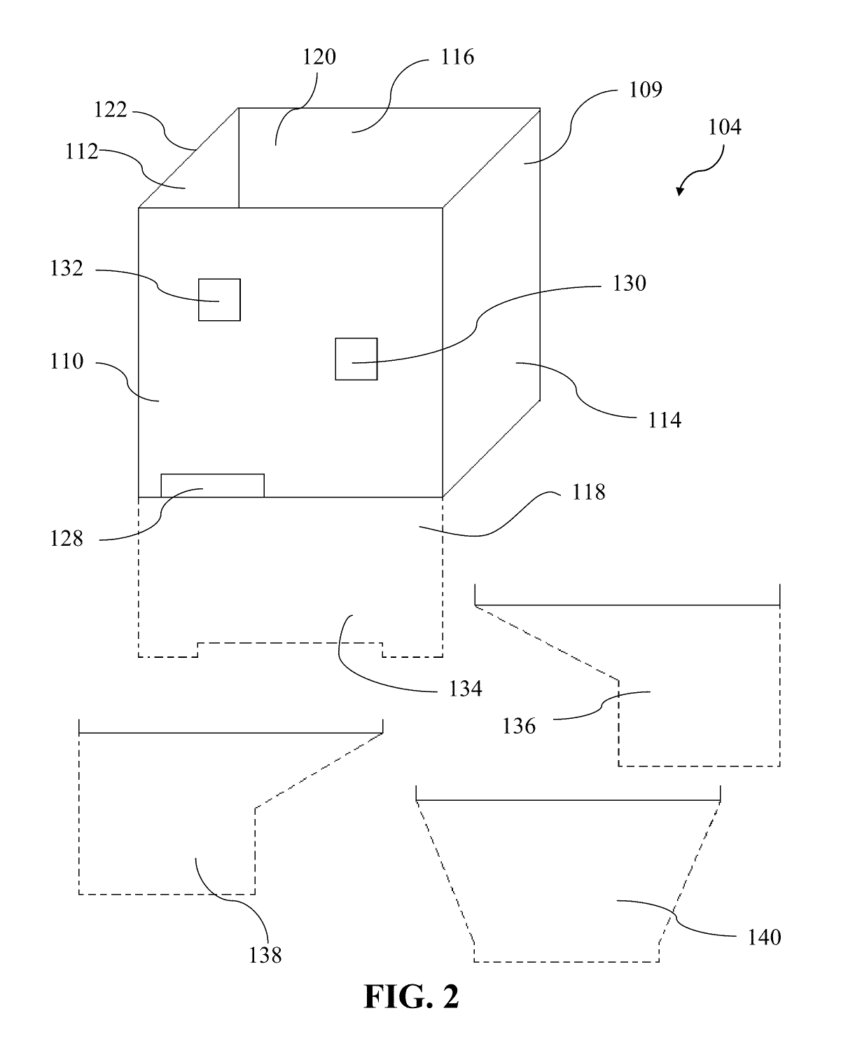

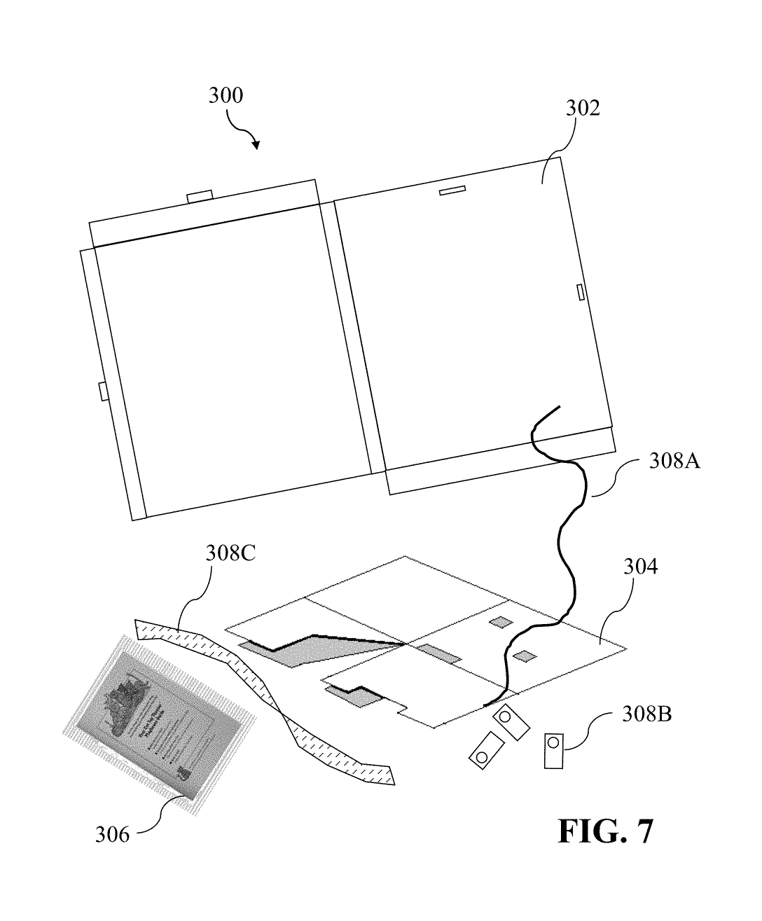

Playhouse 104 can also be made of cardboard or similar materials in various embodiments. In the embodiment shown in FIG. 1, playhouse 104 is foldable so that it can be positioned within packaging 102, as described in more detail below with respect to FIGS. 2 and 7. In embodiments, the largest dimensions of playhouse 104 when folded will be slightly less than the largest dimensions of packaging 102.

Instruction manual 106 can also be arranged within packaging 102, along with playhouse 104. Instruction manual 106 can include multiple types of instructions. For example, instruction manual 106 can include instructions on assembly and use of, and care for, playhouse 104. Additionally, instruction manual 106 can include instructions for proper habituation of a cat to a new living environment, including by using materials of kit 100. The instructions included in instruction manual 106 can be written for the benefit of a person who has not previously lived with a cat, and can include simple or easy to understand instructions about food, play, sleep, and space desired by cats that will help the cat to acclimate to the new environment without becoming aggressive, destructive, or reclusive.

Toy 108 is one of a large variety of toys that could be included in kit 100. In the embodiment shown in FIG. 1, toy 108 is a punch card toy. Toy 108 includes a punch-out aperture 108A (i.e., the perforation described above) that can be removed so that a string or strap can be threaded through. Toy 108, when dragged by a thread, string or strap (such as the ones described below with respect to FIG. 7), can simulate a cat's traditional hunt and prey instincts when dragged across the floor or other surfaces. Toy 108 can help a person who is unused to cat behaviors to play with the cat without significant risk of coming into contact with the cat's claws or teeth. For a person with a low level of experience with a cat, the length of string, thread, yarn, or strap (such as a leather strip) used to drag toy 108 can be extended so that the person's hands are far removed from a cat's playful attacks on toy 108. In embodiments, the punch card can be blank, or can include a drawing or other text or images. Additionally, the punch card can be either pre-punched, or it can include demarcations, perforations, or the like so that a user of the kit 100 can complete the preparation of the punch card toy.

FIG. 2 is an exploded, detail view of the playhouse 104 of FIG. 1. FIG. 2 shows an enclosure 109 extending along a perimeter 122, a floor 118 (shown in dashed lines), and an open top 120. Perimeter 122 is defined by a front wall 110, a first side wall 112, a second side wall 114, and a back wall 116. Playhouse 104 is commonly fabricated with corrugated cardboard, or other materials that have similar characteristics. Each of the front wall 110, first and second side walls 112 and 114, and back wall 116 can be decorated, in embodiments, with art or other coverings. In embodiments, these coverings can be both decorative as well as functional, such as by providing coatings that are bitter or otherwise dissuade a cat from chewing on playhouse 104. In alternative embodiments, holes could be added on the other walls in other variations of the design.

Floor 118 is constructed by a first flap 134, a second flap 136, a third flap 138, and a fourth flap 140 being folded toward each other until they all interact to form a solid base. Flaps 134, 136, 138, and 140 enable playhouse 104 to change between a collapsed configuration when not being used (such as when it is arranged within packaging 102), and an assembled configuration in which enclosure 109 is unfolded to define a hollow center section large enough for a cat. In embodiments, floor 118 can be made of different materials or include other components. For example, in one embodiment the floor 118 is made of a scratching pad. The scratching pad that makes up floor 118 can have greater structural integrity than folded flaps. This increased structural integrity can be used to support various wall types, such as accordion style or walls made of multiple pieces. When floor 118 is made of a scratching pad or other relatively thicker or sturdier material as compared to cardboard flaps, the floor 118 can be angle-cut to permit access to floor aperture 128 from the inside of the playhouse 104. Structural floor components can be used in isolation or in combination with cardboard flaps, in various embodiments.

Front wall 110 comprises a floor aperture 128, a paw aperture 130, and an eye aperture 132. Back wall 116 is opposite apertures 128, 130, and 132. Enclosure 109 formed by these walls provides the cat with a feeling of security to help ease any anxiety it has from being in a new, unfamiliar environment, since back wall 116 does not have any openings that would cause the cat to feel exposed in a direction behind its field of view.

Apertures 128, 130, and 132 provide locations at which the cat can see into, or out of, the playhouse, in order to observe and familiarize itself with the surroundings, as well as interact with humans or toys on the other side. Depending on the cat's level of comfort with its surroundings, the interior of enclosure 109 can provide a feeling of safety for the cat, and as the cat becomes more comfortable it can choose to interact with toys or people outside the enclosure 109 at its own speed.

In some embodiments, the number of or order in which apertures 128, 130, 132 are opened for and made available to the cat can vary in order to aid a cat's adjustment to a new space, human or type of play. To facilitate human interaction with a cat and playhouse 104 in this way, instruction manual 106 can provide guidance to the human for a suggested order in which new ones of apertures 128, 130 and 132 (as well as other toys 108 and interaction techniques) are introduced to a cat.

Large apertures (not shown) can be used as doors for some cats, such as older cats or those with disabilities that are unable to enter or exit over the walls by jumping. In embodiments, the large apertures can be used for a cat to move between different boxes in an arrangement of multiple playhouses. In some embodiments, the apertures can be positioned such that compatible playhouses can be arranged adjacent one another and the apertures are aligned. This allows a cat to travel between multiple playhouses that are next to one another. In embodiments, systems of playhouses can be provided that are all configured to be arranged next to one another so that a cat can travel therebetween, forming “kit towns” that are partially or fully enclosed so that the cat does not need to leave the combined structure when moving from playhouse to playhouse. In embodiments, the walls of playhouses or the connections between playhouses can be clipped together or otherwise connected to prevent displacement between the walls and apertures of adjacent boxes.

Each of these apertures 128, 130, and 132 provides a different benefit to the cat. Floor aperture 128, for example, can provide a simulation of a hunting situation, which cats can find entertaining. Floor aperture 128, as shown in FIGS. 1 and 2, is arranged low to the ground and has a significant width, so that a toy (e.g., toy 108) can be dragged across the area adjacent thereto on a floor or other horizontal surface where the playhouse 104 is located while the cat is inside or outside. If the cat happens to be outside enclosure 109, the human can play through the apertures from the inside, thus keeping a safe distance from claws and teeth.

In other embodiments, kit 100 can include a different size playhouse 104 to accommodate a different sized cat or different activities and interactions for a cat. In some embodiments, kit 100 can even include multiple playhouses 104 that are appropriate for cats of different sizes. This can be particularly useful in situations where a cat is adopted as a juvenile or kitten, or when the adopted cat is undersized because of malnourishment. By providing multiple playhouses 104, the cat can be acclimated to its environment through a small playhouse 104 first, followed by one or more larger playhouses 104 as the cat gets larger. In some embodiments, where packaging 102 is shipped to a new cat owner, a series of packages 102 can be shipped over a period of time corresponding to the cat's expected growth from kitten to juvenile to adult.

Paw aperture 130 and eye aperture 132 provide additional access to play and a way for the cat to observe its environment from a safe location within the playhouse 104. In embodiments, there can be relatively more or fewer paw apertures 130 and eye apertures 132. The size of the apertures 128, 130, and 132 can be sufficient for a cat to see or put a paw through, but small enough that the cat still feels enclosed and safe within the playhouse 104, and also to prevent a cat from being able to attack with both paws or with paws and teeth, which provides a level of safety for a new pet owner playing with the cat through the apertures 128, 130, and 132. In one embodiment, for example, the apertures 130 and 132 can be 50 mm square, while aperture 128 is about 50 mm by about 100 mm. In alternative embodiments, the apertures sizes can range from about 10 mm (for thin observation slits) to about 200 mm (for large play access apertures) in either direction. In one embodiment, the aperture 128 extends away from the floor portion 134 by a distance of about 30 mm and has a width of about 100 mm. In one embodiment the paw aperture and eye aperture 130 and 132 are each about 40 mm by about 40 mm. In the embodiment shown in FIG. 2, the corners of each aperture are squared, but in alternative embodiments the corners could be rounded to enhance safety and comfort of using the kit 100. In embodiments, the playhouse can include a side entrance into the box for cats who are old or disabled and cannot jump. If the playhouse 104 has a flat side, or sides, it can be repositioned in some embodiments so that a flat side becomes the floor and the open top is oriented sideways, allowing the cat to enter without jumping, and the top side can be enclosed like a cave.

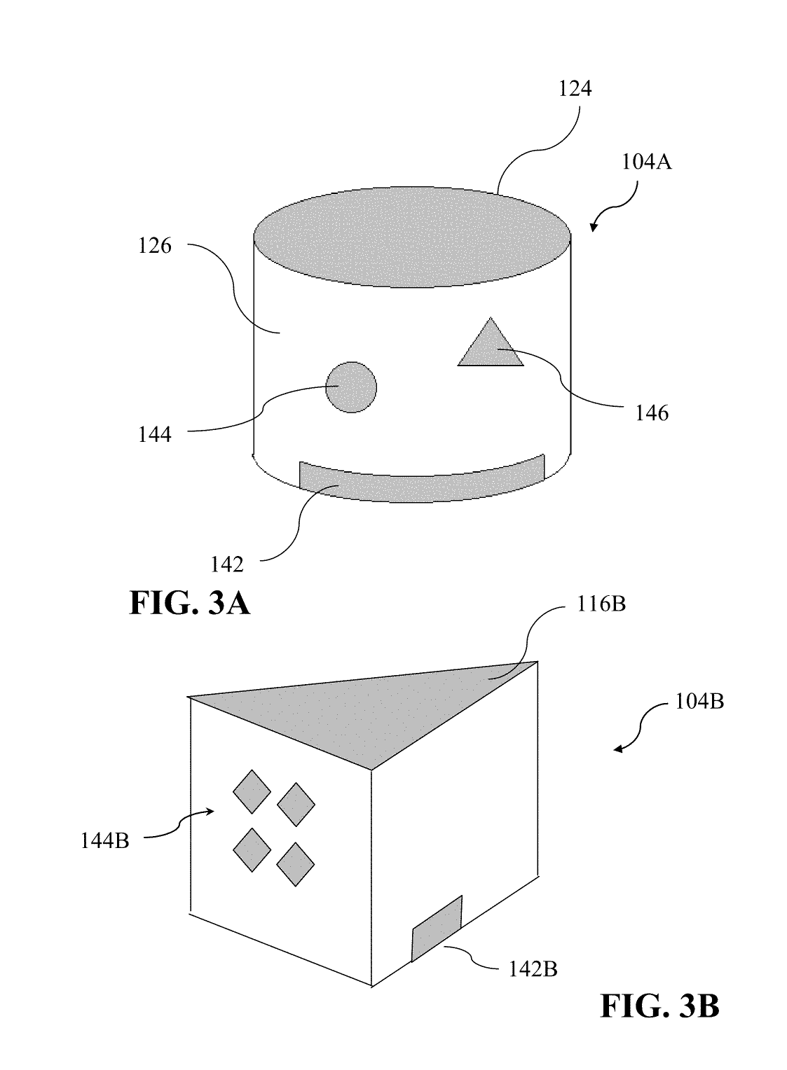

In embodiments, the number, size and shape of apertures can be different, as well as the number of walls and the perimeter shape. For example, FIG. 3A illustrates an embodiment of a playhouse 104A with a circular perimeter 124 and one continuous wall 126. Continuous wall 126 comprises a long floor aperture 142, a circle paw aperture 144, and a triangle eye aperture 146. This disclosure includes any arrangement of walls, as long as there is a solid back section generally oriented opposite of any aperture. While the apertures can also change locations, the elevations are generally maintained at the floor, paw, and eye height in order to accommodate the natural behavior of the cat. A floor height aperture allows the cat to paw at objects on the ground, a paw height aperture allows the cat to reach for toys or play with humans on the other side of the wall at a natural height, and an eye height aperture allows the cat to observe its surroundings so it can get acclimated from a comfortable and secure location. Depending on the size of cat, paw holes and eye holes can be somewhat interchangeable. A larger cat might find the eye aperture useful as a paw aperture, for example. Aperture use will vary by cat, the cat's position in the playhouse, and the play activity. The solid back section further promotes security for the cat, ensuring that nothing will approach it from behind.

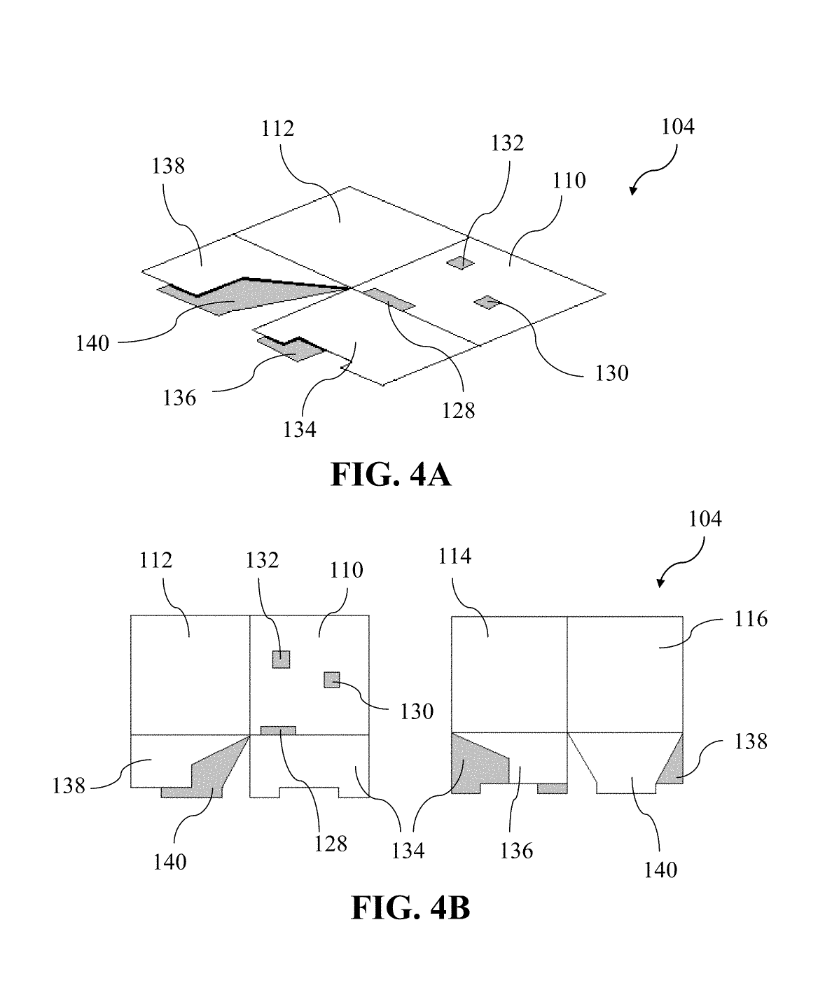

Playhouse (104, 104A, 104B) can also be disassembled into a collapsed configuration, rather than an erect orientation. In one embodiment, as previously explained and illustrated in FIG. 2, flaps 134, 136, 138, and 140 are components of a floor 118. Those flaps (134, 136, 138, and 140) can be unfolded so as to be in the same planes as the walls to which each flap is operably coupled. FIGS. 4A and 4B show one embodiment of playhouse 104 in the disassembled, collapsed configuration. Playhouse 104 can be assembled and disassembled as often as desired. The collapsed configuration makes kit 100 easy to transport and easy to store when not being used. However, when playhouse 104 is not being used by the cat, it can remain erect and be used as a decorative storage container. Artwork or patterns (not shown) can be provided on playhouse 104 that incorporate the apertures on the structure, to inspire cats and their owners to play like they are outside or to provide a pleasing visual appearance to cat owners, some of whom may be unaccustomed to having pet toys in their living spaces.

FIG. 3B is an alternative embodiment of a playhouse 104B having a triangle shape. As described below, artwork can be positioned on the playhouse (104, 104A, 104B). In embodiments, the artwork corresponding to each playhouse can be related to the size or shape of that playhouse. For example, the triangular-shaped playhouse 104B of FIG. 3B could be decorated to look like a piece of cheese in one embodiment. FIG. 3B shows a playhouse 104B that includes a floor aperture 142B, as well as a set of paw holes 144B, on the two walls opposite the back wall 116B. The set of paw holes 144B can be used for a game, together with a toy. By positioning the toy in front of different ones of the apertures within paw holes 144B, a user can create a random pop-up game for a cat. Various colors and patterns can be used in different embodiments. For example, the playhouse (104, 104A, 104B) can have a painted or wrapped pattern that depicts a nature scene of trees or grasses, or one or more colors, or other patterns.

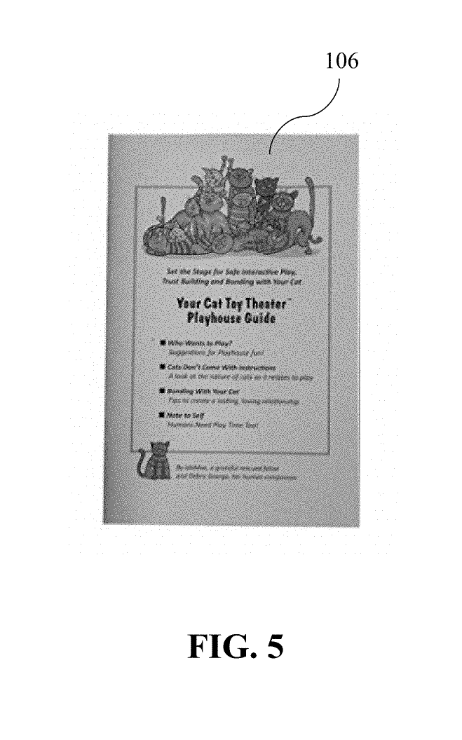

In one embodiment, as illustrated in FIG. 5, instruction manual 106 is a booklet made of paper, or a similar material, that contains information about cats in general, as well as advice for how to understand each cat's individual personality and directions on how to best acclimate a cat to new surroundings and new human companions. Instruction manual 106 explains why it can be difficult to immediately create a positive relationship with a cat, especially a rescued or stray cat, and what the owner can do to try to help the cat overcome its fears and hesitations. Instruction manual 106 offers several suggestions for how to use playhouse 104 and toy 108 to engage a cat in fun and safe activities that will contribute to the growing bond between the cat and its human companion. In one embodiment, toy 108 is a piece of cardboard with a picture of a mouse on it and a location for a hole to be punched. A string, ribbon, or something similar, is meant to be tied to toy 108 and then toy 108 can be dragged across the ground to encourage tracking, chasing, pouncing, and other natural hunting movements. Cats are natural hunters and this is an easy and unthreatening activity to engage the cat's natural curiosity and keep it entertained and exercised. Other embodiments can include different toys and a different number of toys.

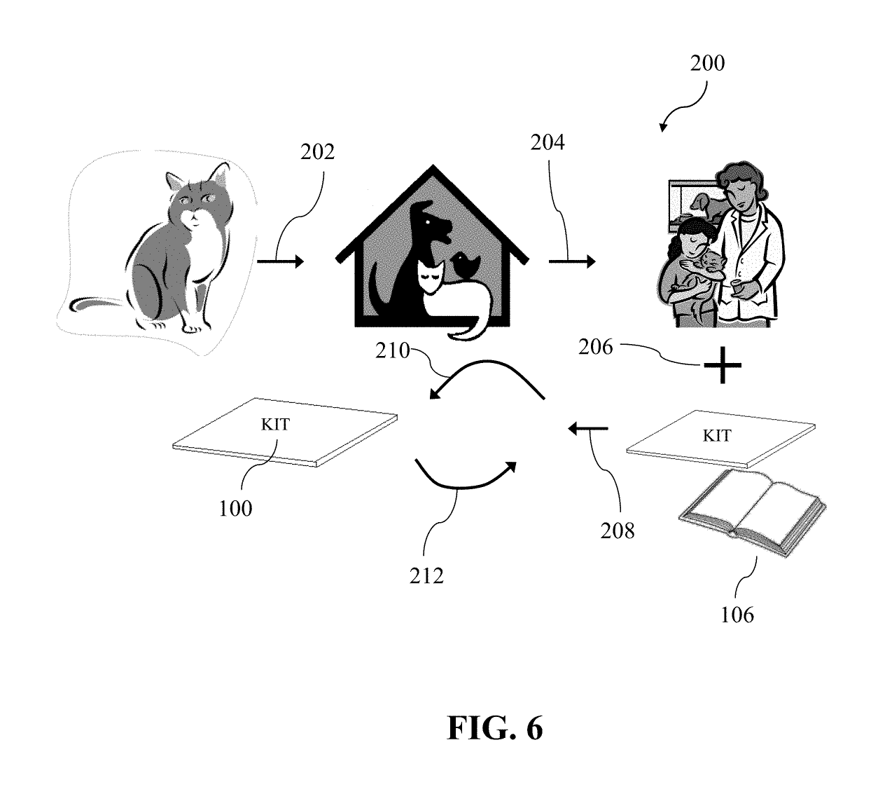

FIG. 6 is a flowchart depicting a method 200 for incorporating kit 100 into the process of providing cats, such as by adoption. Method 200 will ensure new cat owners have the proper equipment to efficiently and safely acclimate a new cat into their home through all stages of the cat's growth and development. As shown in FIG. 6, method 200 can include a rescue shelter or pet store obtaining a cat 202, and the shelter or store transferring responsibility for care of that cat 204 to new owner(s). The owner(s) can acquire a kit 100, as shown at 206. Alternatively, in embodiments the shelter or store can provide the new owner(s) with the kit 100 at 206.

At 208, the owner (or alternatively the shelter or store) orders a new kit 208, either based on the cat outgrowing the original kit at 206 or based on the desire to combine the kit with additional ones to form a “kit kat town” as described above. At 208, the owner reads the manual 106 and assembles playhouse 104.

New or replacement kit can be provided at 210 and can be customized to fit the requirements for the specific cat's needs, or to be compatible with the original kit to expand a network of playhouses, or to increase the number or types of toys for the cat, in embodiments. Adding or replacing kits 210 and 212 can be a repeating cycle that can continue for as long as desired. In one embodiment, the shelter or store can set up automatic recycling or replacement of kits after a certain period of time or owners can email or call the shelter or store and tell them they need a new kit 100. This method can also be incorporated with any person or institution that sells or adopts out cats.

In some embodiments, some of these activities may be omitted or altered. For example, kit 100 can be provided by a veterinarian or other animal support person, rather than a shelter or store. In many embodiments, as described above, kit 100 may be purchased independently by a cat owner, such as via an online website or in a pet store or other retail outlet. Replacing an original kit 100 with a new kit 100 can include an integrated process for recycling the original kit 100, in particular by using the recycled materials from the kit in other uses.

FIG. 7 depicts an alternate embodiment of a kit 300 according to another embodiment. Kit 300 includes packaging 302, playhouse 304, and instructions 306, which are similar to packaging 102 and playhouse 104 described above with respect to the embodiment of FIG. 1. Additionally, kit 300 includes a variety of toys 308A, 308B, 308C. Toy 308A is a string or strap that can be dragged adjacent playhouse 304, either alone or with punch-out tags 308B attached thereto. Other toys 308 included within a kit 300 could be a laser pointer, ribbon, strap, string, feathers, catnip or objects containing catnip, balls, or other toys that are used to play with cats.

Games and activities that are designed for feline entertainment, as well as for health and entertainment of the humans who care for them, can be incorporated into different designs. As described above, kits can include components that are designed for use by a human while the cat is in, on, or otherwise interacting with the playhouse, which provides a game-like environment for both cats and humans. Themes, activities, and games can be customized for cat and human users to interact with one another in a safe and entertaining way.

Various embodiments of apparatuses, kits, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A cat playhouse comprising:
a collapsible enclosure having a wall and a floor, the wall defining an open perimeter opposite the floor;
the collapsible enclosure comprising a floor aperture defined in through the wall and adjacent the floor, wherein the floor aperture has a size of about 100 mm by about 30 mm,
the wall further defining a paw aperture having a size of about 40 mm by about 40 mm, and
the wall further defining an eye aperture having a size of about 40 mm by about 40 mm.

2. The cat playhouse of claim 1, wherein the floor aperture, the paw aperture, and the eye aperture are all arranged at different distances from the floor.

3. The cat playhouse of claim 2, further comprising a back wall opposite the wall, wherein the back wall does not include any apertures.

4. The cat playhouse of claim 1, wherein the floor aperture, the paw aperture, and the eye aperture are all differently shaped from one another.

5. The cat playhouse of claim 1, wherein the floor aperture, the paw aperture, and the eye aperture define a plurality of rounded corners.

6. The cat playhouse of claim 5, wherein the collapsible enclosure is configured to be folded to a flat arrangement.

7. The cat playhouse of claim 1, wherein the wall includes patterns corresponding to an outdoor environment.

8. The cat playhouse of claim 1, wherein the wall is coated with a bitter substance.

9. The cat playhouse of claim 7, wherein the pattern includes artwork.

10. The cat playhouse of claim 9, wherein the artwork generally depicts a nature scene.

11. The cat playhouse of claim 1, wherein the floor comprises four flaps.

12. A kit for aiding interaction between a cat and a human, the kit comprising:
packaging;
a playhouse configured for interaction between cats and human companions, wherein the playhouse includes:
a collapsible enclosure having a wall and a floor, the wall defining an open perimeter opposite the floor;
the collapsible enclosure further defining a floor aperture defined in through the wall and adjacent the floor, wherein the floor aperture has a size of about 100 mm by about 30 mm,
the wall further defining a paw aperture having a size of about 40 mm by about 40 mm, and
the wall further defining an eye aperture having a size of about 40 mm by about 40 mm
an instruction manual; and
a toy.

13. The kit of claim 12, wherein the playhouse includes a back wall opposite the wall, wherein the back wall does not include any apertures.

14. The kit of claim 12, wherein the instruction manual includes information regarding cats and instructions for how to use the kit.

15. The kit of claim 12, wherein the toy is a mouse card toy.

16. The kit of claim 15, wherein the mouse card toy includes a perforation, such that removal of the portion circumscribed by the perforation results in an aperture defined in the mouse card toy.

17. The kit of claim 12, wherein the packaging is configured to enclose the kit when the collapsible enclosure is in a collapsed configuration.

18. A method for incorporating the kit of claim 12 into the process of adopting cats, the method comprising:
obtaining a cat;
providing the cat to an adopter;
providing the adopter with the kit of claim 12;
receiving notice that the cat needs a new kit;
preparing the new kit; and
delivering the new kit to the adopter.

19. The method of claim 17, wherein the sequence of receiving notice that the cat needs a new kit, preparing the new kit, and delivering the new kit to the appropriate recipient are repeated.

20. The method of claim 17, wherein the new kit provided to the adopter is larger than the kit.
